(19) United States
(12) Patent Application Publication
(10) Pub. No.: US 2019/0147261 A1
(43) Pub. Date: May 16, 2019

(54) VEHICLE-MOUNTED INFORMATION PROCESSING DEVICE, VEHICLE-MOUNTED DEVICE, AND VEHICLE-MOUNTED INFORMATION PROCESSING METHOD

(71) Applicant: MITSUBISHI ELECTRIC CORPORATION, Tokyo (JP)

(72) Inventors: Yumi HOSHINA, Tokyo (JP); Taro KUMAGAI, Tokyo (JP); Takashi HIRANO, Tokyo (JP); Masanobu OSAWA, Tokyo (JP)

(73) Assignee: MITSUBISHI ELECTRIC CORPORATION, Tokyo (JP)

(21) Appl. No.: 16/300,142

(22) PCT Filed: Jun. 8, 2016
(86) PCT No.: PCT/JP2016/067052

§ 371 Date: Nov. 9, 2018

(51) Int. Cl. G06K 9/00; G06N 5/04; G10L 17/00

(52) U.S. Cl. CPC G06K 9/00832; G06K 9/00288; G10L 17/005; G06N 5/04

(57) ABSTRACT

Included are a detection information acquiring unit (101) for acquiring detection information showing that an operator's input operation has been detected; a vehicle information acquiring unit (102) for acquiring vehicle information showing the travelling state of a vehicle; an identification processing unit (104) for identifying the operator who has performed the input operation; and a control unit (103) for controlling either output of the detection information or a start of a voice recognition process of recognizing the operator's voice, on the basis of either the vehicle information or the vehicle information and a result of the identification by the identification processing unit.

### TECHNICAL FIELD

The present invention relates to a technique for controlling operational input to a vehicle-mounted device.

### BACKGROUND ART

Navigation equipment, audio equipment, and the like which are mounted in a vehicle accept an input operation by either the driver sitting in the driver's seat or a passenger sitting in the front seat next to the driver or a rear seat via an input operation device, such as a touch panel or a hardware switch, which is arranged between the driver's seat of the vehicle and the front seat next to the driver. Conventionally, a technique for, when the vehicle is in a travelling state, limiting a predetermined input operation is used, so that an input operation by an operator does not obstruct the vehicle's travelling.

For example, an input operation device described in Patent Literature 1 detects the shape of a hand with which an operator has touched a display with a touch panel, determines from the shape of the detected hand that the operator who has operated the display with the touch panel may sit in the driver's seat, and when the vehicle is travelling, determines that the operation by the operator will obstruct the travelling of the vehicle, thereby prohibiting acceptance of the operation.

### CITATION LIST

### Patent Literature

Patent Literature 1: Japanese Unexamined Patent Application Publication No. 2012-32879

### SUMMARY OF INVENTION

### Technical Problem

In the input operation device described in above-mentioned Patent Literature 1, because the driver's manual operation is not accepted when the vehicle is travelling, the driver needs to stop the vehicle or make a request of a passenger to perform an operation on the display with the touch panel in order to operate the display with the touch panel.

On the other hand, even when the driver is prevented from performing a manual operation, the driver can operate navigation equipment, audio equipment, or the like by performing a voice operation by using a voice recognition function mounted in the navigation equipment. However, a problem is that in this case, even though the driver explicitly expresses an intention to operate the navigation device or the audio equipment by bringing his or her finger close to the display with the touch panel, he or she needs to push down an utterance start button or the like mounted on the steering wheel or the like again.

The present invention is made in order to solve the above-mentioned problem, and it is therefore an object of the present invention to provide a technique for, when a driver's manual operation is not accepted, accepting the driver's voice operation while safe driving is ensured.

### Solution to Problem

According to the present invention, there is provided a vehicle-mounted information processing device including: a detection information acquiring unit for acquiring detection information showing that an operator's input operation has been detected; a vehicle information acquiring unit for acquiring vehicle information showing the travelling state of a vehicle; an identification processing unit for identifying the operator who has performed the input operation; and a control unit for controlling either output of the detection information or a start of a voice recognition process of recognizing the operator's voice, on the basis of either the vehicle information or the vehicle information and a result of the identification by the identification processing unit.

### Advantageous Effects of Invention

According to the present invention, the driver's voice operation can be accepted while safe driving is ensured.

### BRIEF DESCRIPTION OF DRAWINGS

FIG. 1 is a block diagram showing the configuration of a vehicle-mounted information processing device according to Embodiment 1;

FIG. 2 is a diagram showing an example of the hardware configuration of the vehicle-mounted information processing device according to Embodiment 1;

FIG. 3 is a flowchart showing the operation of the vehicle-mounted information processing device according to Embodiment 1;

FIG. 4 is a diagram showing a display example when a start of a voice recognition process is instructed by a control unit of the vehicle-mounted information processing device according to Embodiment 1;

FIG. 5 is a block diagram showing the configuration of a vehicle-mounted information processing device according to Embodiment 2;

FIG. 6 is a flowchart showing the operation of the vehicle-mounted information processing device according to Embodiment 2;

FIG. 7 is a block diagram showing the configuration of a vehicle-mounted information processing device according to Embodiment 3;

FIG. 8 is a flowchart showing the operation of the vehicle-mounted information processing device according to Embodiment 3;

FIG. 9 is a block diagram showing the configuration of another example of the vehicle-mounted information processing device according to Embodiment 3; and

FIG. 10 is a block diagram showing the configuration of a vehicle-mounted device which employs the components of the vehicle-mounted information processing device according to Embodiment 1.

### DESCRIPTION OF EMBODIMENTS

Hereafter, in order to explain this invention in greater detail, embodiments of the present invention will be described with reference to the accompanying drawings.

### Embodiment 1

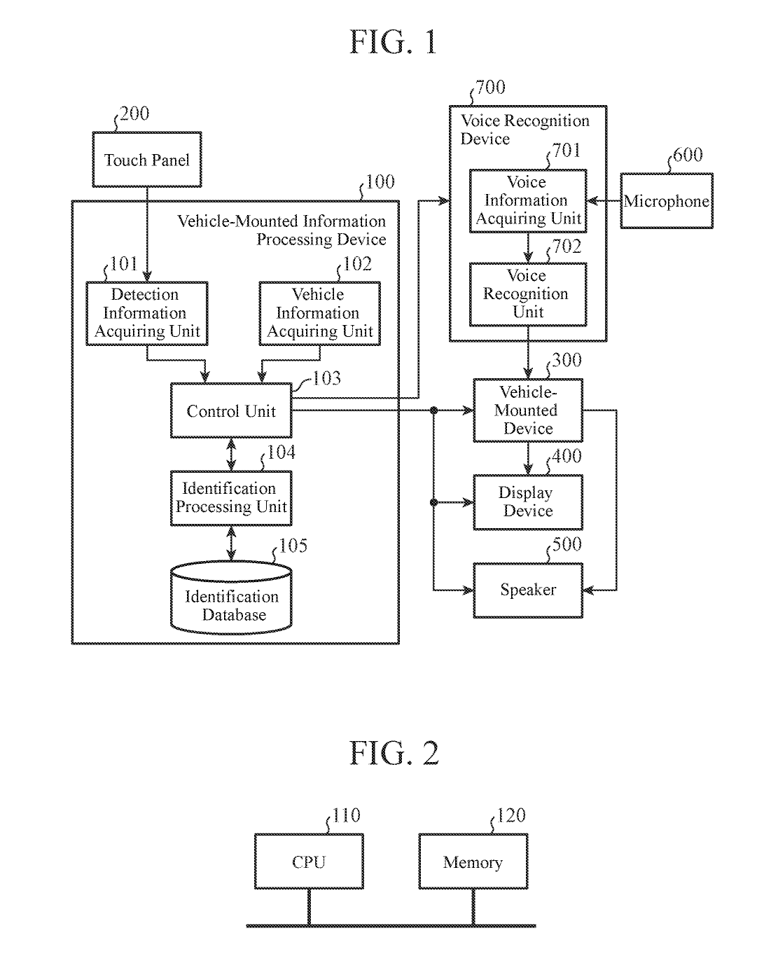

FIG. 1 is a block diagram showing the configuration of a vehicle-mounted information processing device according to Embodiment 1.

The vehicle-mounted information processing device 100 is configured to include a detection information acquiring unit 101, a vehicle information acquiring unit 102, a control unit 103, an identification processing unit 104, and an identification database 105. Further, as shown in FIG. 1, the vehicle-mounted information processing device 100 is connected to a touch panel 200, a vehicle-mounted device 300, a display device 400, a speaker 500, a microphone 600, and a voice recognition device 700.

The detection information acquiring unit 101 acquires detection information from the touch panel 200. The touch panel 200 outputs detection information when detecting an approach or touch of an operator's body, finger, or the like (referred to as an object hereafter). The touch panel 200 is configured in such a way that a capacitive sensing method capable of detecting an approach or touch of an object, a resistance film method capable of detecting a touch of an object, or the like is applied. The touch panel 200 detects an input operation of approaching or touching an object to the touch panel 200 in order for an operator to perform operational input. Coordinate values are provided in advance for an area in the touch panel 200 in which an operator's input operation is to be detected, and the touch panel outputs, as detection information, information indicating a position or a range at/in which an input operation is detected.

In FIG. 1, the example in which the detection information acquiring unit 101 acquires detection information from the touch panel 200 is shown, but the detection information acquiring unit can be alternatively configured to acquire detection information from a touchpad or the like.

The vehicle information acquiring unit 102 acquires information showing a travelling state of the vehicle, such as the speed of the vehicle or the state information about the parking brake, via a not-illustrated vehicle-mounted network or the like.

When the detection information about an input operation is inputted from the detection information acquiring unit 101, the control unit 103 performs a process corresponding to the information acquired by the vehicle information acquiring unit 102 and showing the travelling state of the vehicle. When determining from the information showing the travelling state of the vehicle that the vehicle is stationary or parked, the control unit 103 outputs the detection information at the time of the input operation, the detection information being inputted from the detection information acquiring unit 101, as control information, to the vehicle-mounted device 300.

In contrast, when determining that the vehicle is travelling, the control unit 103 analyzes the detection information at the time of the input operation, extracts a feature quantity of the object with which the input operation has been performed, and outputs the feature quantity to the identification processing unit 104. The control unit 103 refers to a result of identification of the operator, the result being inputted from the identification processing unit 104, and, when the vehicle is travelling and the operator is a passenger, outputs the detection information at the time of the input operation, the detection information being inputted from the detection information acquiring unit 101, as control information, to the vehicle-mounted device 300. Further, the control unit 103 refers to the result of the identification of the operator, the result being inputted from the identification processing unit 104, and, when the vehicle is travelling and the operator is the driver, instructs the voice recognition device 700 to start a voice recognition process.

Here, the feature quantity of the object at the time of the input operation, the feature quantity being extracted by the control unit 103, is the shape of the operator's hand or finger, a combination of the apex of the operator's index finger and the shape of the operator's hand or finger, or the like when, for example, the operator has pressed down, as the input operation, a button of the touch panel 200 by using his or her index finger. The above-mentioned feature quantity is an example, and any information can be used as the feature quantity as long as the information makes it possible to identify the object with which the input operation has been performed.

More detailed control content of the control unit 103 will be mentioned later.

The identification processing unit 104 makes a comparison between the feature quantity of the object with which the input operation has been performed, the feature quantity being extracted by the control unit 103, and feature quantities stored in the identification database 105, and identifies whether the operator who has performed the input operation is the driver or a passenger other than the driver. The identification processing unit 104 outputs the result of the identification of the operator who has performed the input operation to the control unit 103.

Concretely, explaining, as an example, a case in which the vehicle is a right-hand drive vehicle, when the degree of matching between the feature quantity of the object with which the input operation has been performed, the feature quantity being extracted, and the feature quantity of the shape of a left hand, the feature quantity being stored in the identification database 105 on the assumption that the left hand is used in an input operation, is equal to or greater than a threshold, the identification processing unit 104 identifies that the operator is the driver. Further, when the degree of matching between the feature quantity of the object with which the input operation has been performed, the feature quantity being extracted, and the feature quantity of the shape of a right hand, the feature quantity being stored in the identification database 105 on the assumption that the right hand is used in an input operation, is equal to or greater than a threshold, the identification processing unit 104 identifies that the operator is a passenger.

The identification database 105 stores a feature quantity of an object on the assumption that the driver performs an input operation, and a feature quantity of an object on the assumption that a passenger sitting in the front seat next to the driver performs an input operation. For example, in the case in which the vehicle is a right-hand drive vehicle, the identification database 105 stores the shape of a hand, a direction pointed by a finger, the angle of a hand, and so on each of which is assumed to be extracted from a right hand approaching or being close to the touch panel 200 when a passenger sitting in the front seat next to the driver operates the touch panel 200 with the right hand. Similarly, the identification database 105 stores a feature quantity of a shape, a direction pointed by a finger, the angle of a hand, and so on each of which is assumed to be extracted from a left hand approaching or being close to the touch panel 200 when the driver sitting in the driver's seat operates the touch panel 200 with the left hand. The angle of a hand is, for example, the inclination with respect to a side of the touch panel 200.

In a case in which the vehicle is a left-hand drive vehicle, a correspondence between the driver, and the feature quantity of the shape of his or her right hand and so on, a correspondence between a passenger, and the feature quantity of the shape of his or her left hand and so on can be stored in the identification database 105.

The vehicle-mounted device 300 is a navigation device, an audio device, or the like which are mounted in the vehicle. The vehicle-mounted device 300 controls itself on the basis of the information showing the position or the range at/in which the input operation has been detected, the information being shown in the detection information inputted from the control unit 103.

The display device 400 includes, for example, a liquid crystal display or an organic EL (electroluminescence), and displays information of which the driver and a passenger are notified, on the basis of pieces of control information inputted from the vehicle-mounted information processing device 100 and the vehicle-mounted device 300. Concretely, in a case in which the vehicle-mounted device 300 is a navigation device, the display device 400 displays information including, for example, a map, a place of departure, a destination, and a guide route on the basis of the control information inputted from the vehicle-mounted information processing device 100. Further, the display device 400 displays a screen providing a notification of a start of the voice recognition process, a voice recognition result, and so on, on the basis of the information inputted from the vehicle-mounted device 300. In addition, in the case in which the vehicle-mounted device 300 is a navigation device, the display device 400 displays the information including, for example, the map, the place of departure, the destination, and the guide route.

A configuration can be provided in which the display device 400 is integral with the touch panel 200, and input to the touch panel 200 is accepted as an operation of selecting information displayed on the display device 400.

The speaker 500 outputs by voice the information of which the driver and a passenger are notified on the basis of the pieces of control information inputted from the vehicle-mounted information processing device 100 and the vehicle-mounted device 300. Concretely, a voice providing a notification of a start of the voice recognition process, the voice recognition result, and so on is outputted on the basis of the control information inputted from the control unit 103.

The microphone 600 collects a voice provided by an occupant in the vehicle. As the microphone 600, for example, an omnidirectional microphone, an array microphone in which plural omnidirectional microphones are arranged in an array form and their directional characteristics are adjusted, or a unidirectional microphone having directivity only in one direction can be used.

The voice recognition device 700 includes a voice information acquiring unit 701 and a voice recognition unit 702. When control information instructing a start of the voice recognition process is inputted from the vehicle-mounted information processing device 100 to the voice recognition device 700, the voice information acquiring unit 701 acquires information on the voice collected by the microphone 600 and A/D (Analog/Digital) converts this information by using, for example, PCM (Pulse Code Modulation). The microphone 600 can be configured to include the voice information acquiring unit 701, and A/D convert voice information at all times.

The voice recognition unit 702 detects a voice section corresponding to content uttered by a user from a voice signal subjected to A/D conversion with the voice information acquiring unit 701, extracts a feature quantity of voice data of this voice section, performs a recognition process on the basis of the extracted feature quantity by using a voice recognition dictionary, and outputs a recognition result to the vehicle-mounted device 300. The recognition process can be performed by using, for example, a typical method such as an HMM (Hidden Markov Model) method.

In addition to starting the voice recognition process on the basis of the control information from the vehicle-mounted information processing device 100, when, for example, a button mounted on the touch panel, the steering wheel, or the like and instructing a start of the voice recognition is pushed down, the voice recognition device 700 can start the voice recognition process on the voice information collected by the microphone 600 in accordance with information showing the pressing of the button.

Next, an example of the hardware configuration of the vehicle-mounted information processing device 100 will be explained.

FIG. 2 is a diagram showing an example of the hardware configuration of the vehicle-mounted information processing device according to Embodiment 1.

The detection information acquiring unit 101, the vehicle information acquiring unit 102, the control unit 103, and the identification processing unit 104 in the vehicle-mounted information processing device 100 are implemented by a processing circuit. More specifically, the detection information acquiring unit 101, the vehicle information acquiring unit 102, the control unit 103, and the identification processing unit 104 include a processing circuit that extracts a feature point of an object from the detection information about an input operation, identifies whether the operator is the driver or a passenger, and, when the operator is the driver, instructs a start of the voice recognition process.

In a case in which the processing circuit is hardware for exclusive use, the processing circuit is, for example, a single circuit, a composite circuit, a programmable processor, a parallel programmable processor, an ASIC (Application Specific Integrated Circuit), an FPGA (Field-programmable Gate Array), or a combination of these circuits. Each of the functions of the detection information acquiring unit 101, the vehicle information acquiring unit 102, the control unit 103, and the identification processing unit 104 can be implemented by a processing circuit, or the functions of the units can be implemented collectively by a processing circuit.

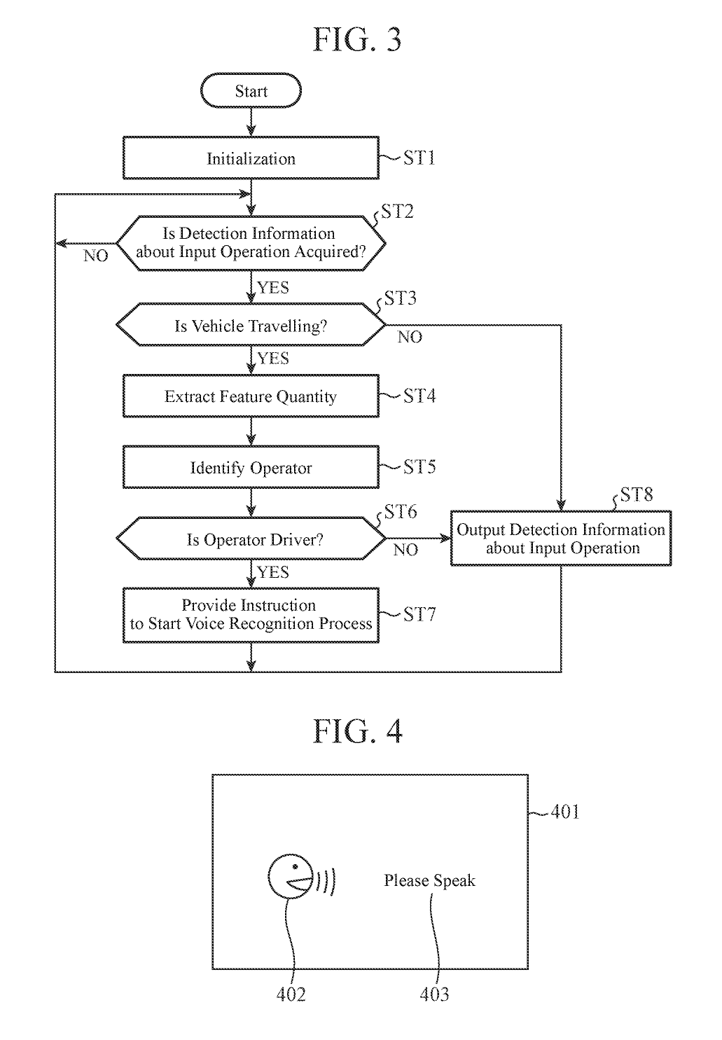

In a case in which the processing circuit is a CPU (Central Processing Unit), the processing circuit is a CPU 110 that executes a program stored in a memory 120 shown in FIG. 2. Each of the functions of the detection information acquiring unit 101, the vehicle information acquiring unit 102, the control unit 103, and the identification processing unit 104 is implemented by software, firmware, or a combination of software and firmware. The software or the firmware is described as a program and the program is stored in the memory 120. The CPU 110 implements each of the functions of the detection information acquiring unit 101, the vehicle information acquiring unit 102, the control unit 103, and the identification processing unit 104 by reading and executing a program stored in the memory 120. More specifically, the detection information acquiring unit 101, the vehicle information acquiring unit 102, the control unit 103, and the identification processing unit 104 include the memory 120 for storing programs by which each of steps mentioned later and shown in FIG. 3 is performed as a result when the programs are executed by the CPU 110. Further, it can be said that these programs cause a computer to execute procedures or methods which the detection information acquiring unit 101, the vehicle information acquiring unit 102, the control unit 103, and the identification processing unit 104 use.

Here, the CPU 110 is, for example, a central processing unit, a processing device, an arithmetic device, a processor, a microprocessor, a microcomputer, or a DSP (Digital Signal Processor).

The memory 120 is, for example, a non-volatile or volatile semiconductor memory such as a RAM (Random Access Memory), a ROM (Read Only Memory), a flash memory, an EPROM (Erasable Programmable ROM), or an EEPROM (Electrically EPROM), a magnetic disk such as a hard disk or a flexible disk, or an optical disc such as a mini disc, a CD (Compact Disc), or a DVD (Digital Versatile Disc).

Next, the control content of the control unit 103 will be explained in greater detail.

Hereafter, an explanation will be made while cases are divided into three in accordance with both the travelling state of the vehicle, and the result of the identification of the operator.

(1-1) In a Case in which the Vehicle is Stationary or Parked

The control unit 103 refers to the travelling state of the vehicle acquired from the vehicle information acquiring unit 102, and, when the vehicle speed is “0” or the parking brake is in the ON state, determines that the vehicle is stationary or parked.

The control unit 103 outputs the information showing the position or the range at/in which the input operation has been detected, the information being described in the detection information acquired by the detection information acquiring unit 101, to the vehicle-mounted device 300.

The vehicle-mounted device 300 identifies the operator's operation on the basis of the inputted information showing the position or the range, and performs a process corresponding to the identified operation.

(1-2) In a Case in which the Vehicle is Travelling and the Result of the Identification of the Operator Shows a Passenger

The control unit 103 refers to the travelling state of the vehicle acquired from the vehicle information acquiring unit 102, and, when a state in which the vehicle speed is equal to or higher than a preset vehicle speed continues a predetermined time, determines that the vehicle is travelling. Here, the preset vehicle speed is, for example, 5 km per hour. Further, the predetermined time is, for example, 3 seconds.

In addition, the control unit 103 refers to the result of the identification of the operator, the result being inputted from the identification processing unit 104, and, when determining that the operator is a passenger, outputs the information showing the position or the range at/in which the input operation has been detected, the input operation being described in the detection information acquired by the detection information acquiring unit 101, to the vehicle-mounted device 300. More specifically, the control unit 103 accepts an operation which the operator performs via the touch panel 200.

The vehicle-mounted device 300 identifies the operator's operation on the basis of the inputted information showing the position or the range, and performs a process corresponding to the identified operation.

(1-3) In a Case in which the Vehicle is Travelling and the Result of the Identification of the Operator Shows the Driver

The control unit 103 refers to the travelling state of the vehicle acquired from the vehicle information acquiring unit 102, and, when the state in which the vehicle speed is equal to or higher than the preset vehicle speed continues the predetermined time, determines that the vehicle is travelling.

In addition, the control unit 103 refers to the result of the identification of the operator, the result being inputted from the identification processing unit 104, and, when determining that the operator is the driver, outputs control information instructing a start of the voice recognition process to the voice recognition device 700. More specifically, the control unit 103 does not accept an operation which the operator performs via the touch panel 200, and shifts to the voice recognition process.

The vehicle-mounted device 300 identifies the operator's operation on the basis of a voice recognition result inputted from the voice recognition device 700, and performs a process corresponding to the identified operation.

Next, the operation of the vehicle-mounted information processing device 100 will be explained.

FIG. 3 is a flowchart showing the operation of the vehicle-mounted information processing device 100 according to Embodiment 1.

When the vehicle-mounted information processing device 100 is activated, the setting values of the vehicle-mounted information processing device 100 are initialized (step ST1). Next, the detection information acquiring unit 101 determines whether or not detection information about an input operation, the detection information showing that an object is approaching or has touched the touch panel 200, is acquired (step ST2). When detection information about an input operation is not acquired (NO in step ST2), the determining process in step ST2 is repeated.

In contrast, when detection information about an input operation is acquired (YES in step ST2), the detection information acquiring unit 101 outputs the acquired detection information about an input operation to the control unit 103. When the detection information about an input operation is inputted, the control unit 103 refers to the information showing the travelling state of the vehicle, the information being inputted at all times or at predetermined time intervals from the vehicle information acquiring unit 102, to determine whether or not the vehicle is travelling (step ST3). When the vehicle is not travelling (NO in step ST3), the control unit 103 advances to a process of step ST8 mentioned later. In contrast, when the vehicle is travelling (YES in step ST3), the control unit 103 analyzes the detection information about an input operation, detects the shape of an object, and extracts the feature quantity of the detected shape (step ST4). The identification processing unit 104 makes a comparison between the feature quantity extracted in step ST4 and the feature quantities stored in the identification database 105, to identify whether the operator is the driver or a passenger (step ST5). The control unit 103 refers to a result of the identification of the operator, to determine whether or not the operator is the driver (step ST6).

When the operator is the driver (YES in step ST6), the control unit 103 outputs control information instructing a start of the voice recognition process to the voice recognition device 700 (step ST7). After that, the flowchart returns to the process of step ST2. In contrast, when the operator is not the driver (NO in step ST6), the control unit 103 outputs the detection information about an input operation to the vehicle-mounted device 300 (step ST8). After that, the flowchart returns to the process of step ST2.

When the control unit 103, in step ST7, outputs the control information instructing a start of the voice recognition process to the voice recognition device 700, the voice recognition device 700 starts the voice recognition process on the information on voice collected via the microphone 600. In that case, the voice recognition device 700 displays information showing that the voice recognition process has been started, i.e., a voice operation has become possible to the display device 400 via the vehicle-mounted device 300. Similarly, the voice recognition device 700 outputs by voice the information showing that the voice recognition process has been started, i.e., a voice operation has become possible to the speaker 500 via the vehicle-mounted device 300.

FIG. 4 shows a display example after an instruction to start the voice recognition process is provided by the control unit 103 of the vehicle-mounted information processing device 100 according to Embodiment 1.

On the screen 401 of the display device 400, at least one of an icon 402 and a message 403 which provide a notification that voice input is currently being accepted is displayed. The driver utters in accordance with the icon 402 or the message 403.

As mentioned above, according to Embodiment 1, it is configured to include: the detection information acquiring unit 101 that acquires detection information showing that an operator's input operation has been detected; the vehicle information acquiring unit 102 that acquires vehicle information showing the travelling state of the vehicle; the identification processing unit 104 that identifies the operator who has performed the input operation; and the control unit 103 that controls either output of the detection information or a start of the voice recognition process of recognizing the operator's voice, on the basis of either the vehicle information or the vehicle information and a result of the identification by the identification processing unit 104. Thus, it is possible to accept the driver's voice operation without performing a complicated operation while safe driving is ensured.

Further, according to Embodiment 1, it is configured in such a way that when determining from the vehicle information that the vehicle is travelling, the control unit 103 extracts a feature quantity of the operator from the detection information, and the identification processing unit 104 makes a comparison of the feature quantity of the operator which is extracted by the control unit 103, to identify whether or not the operator is the driver, and, when the identification processing unit 104 identifies that the operator is the driver, the control unit 103 controls a start of the voice recognition process. Thus, when the driver's manual operation is not accepted, it is possible to accept the driver's voice operation without performing a complicated operation while safe driving is ensured.

### Embodiment 2

In above-mentioned Embodiment 1, the configuration in which the operator who has performed an input operation inputted via the touch panel 200 is identified using the detection information inputted from the touch panel 200 is shown. In Embodiment 2, a configuration in which an operator is identified using detection information acquired from an image shot by an infrared camera will be shown.

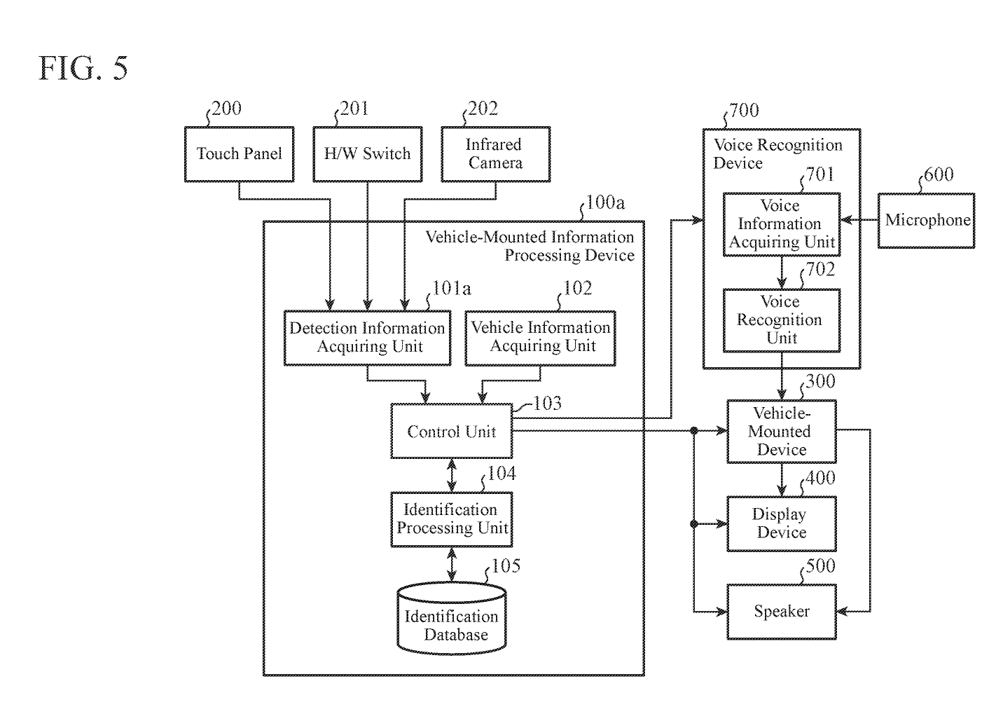

FIG. 5 is a block diagram showing the configuration of a vehicle-mounted information processing device 100a according to Embodiment 2.

A detection information acquiring unit 101a of the vehicle-mounted information processing device 100a of Embodiment 2 acquires detection information from a touch panel 200 or a hardware switch (referred to as an H/W switch hereafter) 201, and acquires a shot image from the infrared camera 202. Hereafter, the same components or the corresponding components as those of the vehicle-mounted information processing device 100 according to Embodiment 1 are denoted by the same reference numerals as those used in Embodiment 1, and an explanation of the components will be omitted or simplified. Further, the detection information acquiring unit 101a can acquire detection information from a touchpad or the like in addition to the touch panel 200 and the H/W switch 201.

When detecting an approach or touch of an operator's object, the touch panel 200 outputs, as detection information, information showing a position or a range at/in which an input operation has been detected to the detection information acquiring unit 101a. Further, when pressed, the H/W switch 201 outputs, as detection information, information about the switch which has detected the input operation to the detection information acquiring unit 101a.

The infrared camera 202 shoots an area where an operator performs an input operation, and outputs a shot image to the detection information acquiring unit 101a. The infrared camera 202 is mounted, for example, above or on the touch panel 200, a vehicle-mounted device 300 fitted into a dashboard, or a display device 400. The infrared camera 202 is configured to be able to shoot a wide area so that the camera can shoot an area where an operator performs an input operation. Concretely, as the infrared camera 202, plural cameras with a wide angle of view which are arranged in such a way that the touch panel 200, the H/W switch 201, the touchpad, or the like can be shot are used.

The detection information acquiring unit 101a acquires detection information from the touch panel 200 or the H/W switch 201. The detection information acquiring unit 101a also acquires a shot image from the infrared camera 202. The detection information acquiring unit 101a refers to the shot image of the infrared camera 202, and acquires, as detection information, either a shot image showing that an object is approaching or has touched the touch panel 200, or a shot image showing that an object has pressed down the H/W switch 201. In this case, the detection information acquiring unit 101a stores a preset area in a shot image of the infrared camera 202 on the assumption that an object with which an input operation is performed is captured. When a part with predetermined brightness or greater has been detected in a shot image of the area during a predetermined time period or longer (e.g., one second), the detection information acquiring unit 101a determines that an object is approaching or has touched the touch panel 200 or the H/W switch 201, and acquires the shot image as detection information.

The brightness of a shot image is expressed in, for example, 255 levels by using a value of “0” to “254.” For example, when the brightness value in the preset area of a shot image is equal to or greater than, e.g., “150”, the detection information acquiring unit 101a determine that an object with which an input operation is performed is shot and associates brightness with an approaching state or a touching state of an object in advance.

Further, in a case in which the infrared camera 202 is arranged at a position where the touch panel 200 or the H/W switch 201 can be shot, the detection information acquiring unit 101a stores an area corresponding to the arrangement position of the touch panel 200 or the H/W switch 201 in a shot image of the infrared camera 202, and determines whether or not the predetermined brightness or greater has been detected in a shot image of the area during the predetermined time period or longer.

When the detection information of the touch panel 200 or the H/W switch 201 is inputted from the detection information acquiring unit 101a and it is determined from information showing the travelling state of the vehicle acquired by a vehicle information acquiring unit 102 that the vehicle is stationary or parked, a control unit 103 outputs the detection information of the touch panel 200 or the H/W switch 201, as control information, to the vehicle-mounted device 300.

In contrast, when the detection information of the touch panel 200 or the H/W switch 201 is inputted from the detection information acquiring unit 101a and it is determined from the information showing the travelling state of the vehicle acquired by the vehicle information acquiring unit 102 that the vehicle is travelling, the control unit 103 analyzes the detection information inputted from the detection information acquiring unit 101a and acquired from the shot image of the infrared camera 202, extracts a feature quantity of the object with which the input operation has been performed, and outputs the feature quantity to an identification processing unit 104.

Here, the feature quantity of the object at the time of the input operation, the feature quantity being extracted by the control unit 103, is, for example, the shapes of the operator's hand and finger, a combination of the shapes of the operator's hand and finger and the direction in which the operator's arm approaches, a combination of the apex of the operator's index finger, and the shapes of the operator's hand and finger, or a combination of the apex of the operator's index finger, the shapes of the operator's hand and finger, and the direction in which the operator's arm approaches. The above-mentioned feature quantity is an example, and any information can be used as the feature quantity as long as the information makes it possible to identify the operator's input operation.

By acquiring a shot image from the infrared camera 202 as detection information, the control unit 103 can extract the direction from which the arm approaches as a feature quantity in addition to detecting the shapes of a hand and a finger.

Next, the process of, in the control unit 103, extracting a feature quantity from the detection information acquired from a shot image of the infrared camera 202 will be explained concretely.

When extracting a feature quantity from the shape of the operator's hand, the control unit 103 analyzes the shot image which is the detection information and extracts a feature quantity of an area where a brightness value is equal to or greater than a predetermined value. When the brightness value of the shot image is expressed in 255 levels of 0 to 254, the control unit 103 extracts an area where the brightness value shows, for example, a value of 150 or more, and extracts, as a feature quantity, the shapes of the outlines of a hand and a finger or the position of the apex of each finger from the area.

When extracting a feature quantity from the direction in which the operator's arm approaches, the control unit 103 analyzes the shot image which is the detection information and extracts a feature quantity of an area where the brightness value is equal to or greater than the predetermined value. The control unit 103 extracts an area where the brightness value shows, for example, a value of 150 or more, and, in addition to extracting, as a feature quantity, the shapes of the outlines of a hand and a finger or the position of the apex of each finger from the area, approximates an area corresponding to the arm to a rectangular region and extracts an inclination of the approximate rectangular region as a feature quantity. The inclination of the rectangular region is an inclination with respect to, for example, a vertical axis or a horizontal axis of the shot image.

The identification processing unit 104 makes a comparison between the feature quantity extracted by the control unit 103 and feature quantities stored in an identification database 105, to identify the operator.

In this case, the shapes of hands, the direction in which the operator's arm approaches, and so on are stored in the identification database 105 as feature quantities of objects.

The identification processing unit 104 makes a comparison between the extracted feature quantity of the shape of a hand, and the feature quantities stored in the identification database 105, to identify whether or not the operator is the driver, like that of Embodiment 1. As an alternative, the identification processing unit 104 makes a comparison between the feature quantity of both the shape of the operator's hand and the direction in which the operator's arm approaches, and the feature quantities stored in the identification database 105, to identify whether or not the operator is the driver. In the identification of whether or not the operator is the driver, the identification processing unit 104 makes a comparison using the direction in which the operator's arm approaches in addition to the shape of a hand, thereby being able to improve the accuracy at the time of identifying the operator.

Next, the operation of the vehicle-mounted information processing device 100a will be explained.

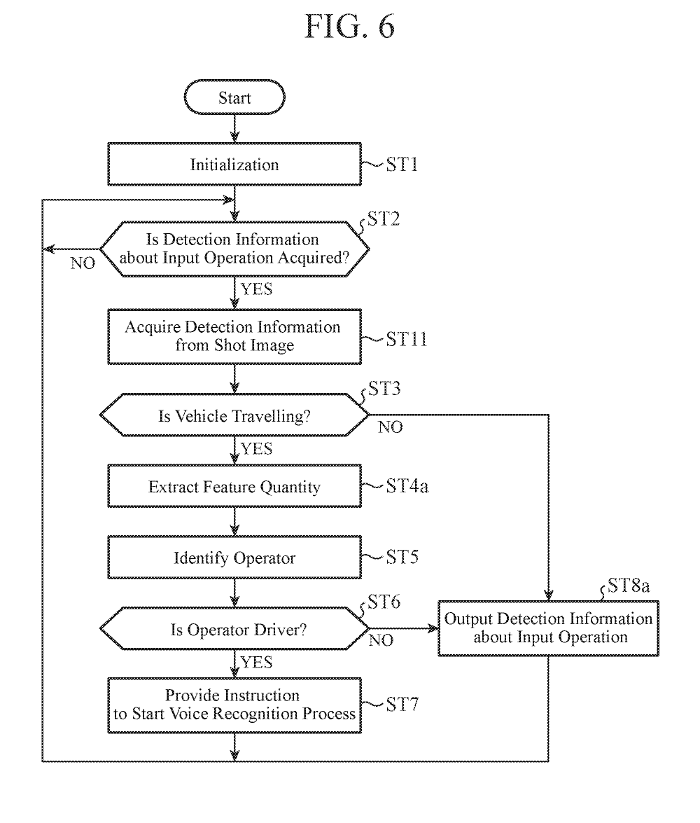

FIG. 6 is a flowchart showing the operation of the vehicle-mounted information processing device 100a according to Embodiment 2.

Hereafter, the same steps as those of the vehicle-mounted information processing device 100 according to Embodiment 1 are denoted by the same reference numerals as those used in FIG. 3, and an explanation of the steps will be omitted or simplified.

The detection information acquiring unit 101a determines whether or not detection information about an input operation, the detection information showing that an object is approaching or has touched the touch panel 200 or that an object has pressed down the H/W switch 201, is acquired (step ST2). When detection information about an input operation is not acquired (NO in step ST2), the determining process of step ST2 is repeated.

When the detection information acquiring unit 101a, in step ST2, acquires detection information about an input operation (YES in step ST2), the detection information acquiring unit 101a further acquires detection information about the input operation from a shot image of the infrared camera 202 (step ST11). The detection information acquiring unit 101a outputs the acquired pieces of detection information about the input operation to the control unit 103. When the pieces of detection information about the input operation are inputted, the control unit 103 refers to the information showing the travelling state of the vehicle which is inputted at all times or at predetermined time intervals from the vehicle information acquiring unit 102, to determine whether or not the vehicle is travelling (step ST3). When the vehicle is not travelling (NO in step ST3), the control unit 103 advances to a process of step ST8a mentioned later.

In contrast, when the vehicle is travelling (YES in step ST3), the control unit 103 analyzes the detection information acquired from the shot image, out of the pieces of detection information about the input operation, detects the shape of an object, and extracts the feature quantity of the detected shape (step ST4a). The identification processing unit 104 makes a comparison between the feature quantity extracted in step ST4a and the feature quantities stored in the identification database 105, to identify whether the operator is the driver or a passenger (step ST5). The control unit 103 refers to a result of the identification of the operator, to determine whether or not the operator is the driver (step ST6).

When the operator is the driver (YES in step ST6), the control unit 103 outputs control information instructing a start of a voice recognition process to a voice recognition device 700 (step ST7). After that, the flowchart returns to the process of step ST2. In contrast, when the operator is not the driver (NO in step ST6), the control unit 103 outputs the detection information acquired from the touch panel 200 or the H/W switch 201, out of the pieces of detection information about the input operation, to the vehicle-mounted device 300 (step ST8a). After that, the flowchart returns to the process of step ST2.

As mentioned above, according to Embodiment 2, it is configured in such a way that the detection information acquiring unit 101 acquires a shot image acquired by shooting an operator's input operation, and the control unit 103 extracts a feature quantity of the operator from the shot image. Thus, even in a case in which the vehicle-mounted device is operated via the H/W switch, a shift to a voice operation can be performed without troubling the driver when the driver operates the H/W switch while the vehicle is travelling. Therefore, it is possible to accept the driver's voice operation without performing a complicated operation while safe driving is ensured.

Further, according to Embodiment 2, it is configured in such a way that the detection information acquiring unit 101 acquires a shot image acquired by shooting an area where an operator performs an input operation, and the control unit 103 also takes into consideration the direction in which the operator's arm approaches as a feature quantity of an object at the time of an input operation, the accuracy at the time of identifying the operator can be improved.

### Embodiment 3

In Embodiment 3, a configuration of predicting whether a vehicle will start to travel, and determining whether or not to start a voice recognition process by using a result of the prediction will be shown.

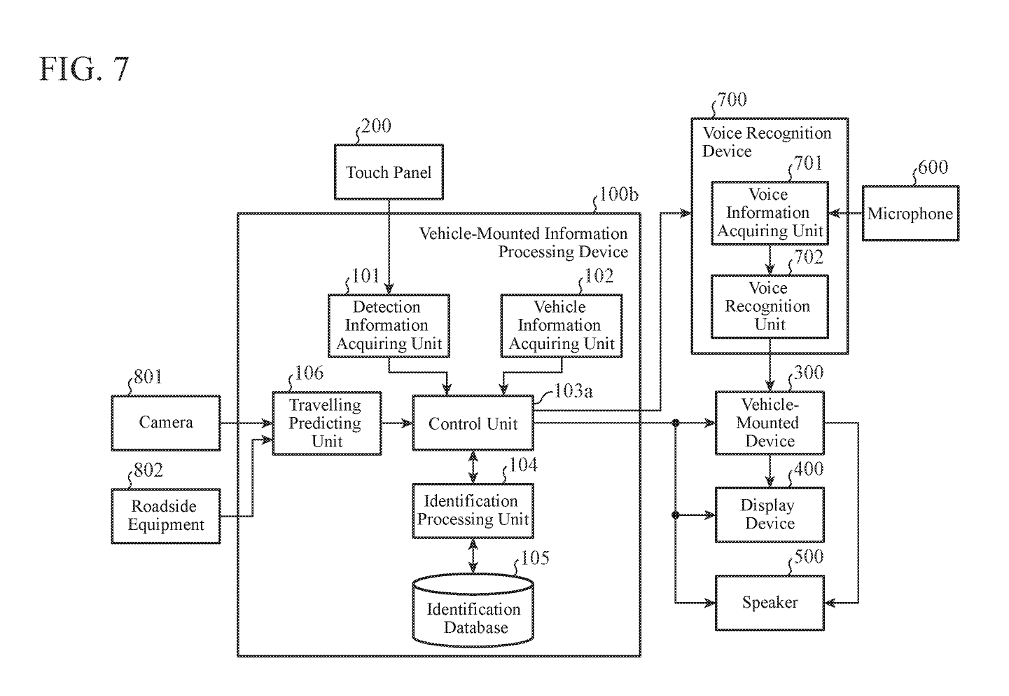

FIG. 7 is a block diagram showing the configuration of a vehicle-mounted information processing device 100b according to Embodiment 3. The vehicle-mounted information processing device 100b of Embodiment 3 additionally includes a travelling predicting unit 106, and is configured by replacing the control unit 103 with a control unit 103a. Hereafter, the same components or the corresponding components as those of the vehicle-mounted information processing device 100 according to Embodiment 1 are denoted by the same reference numerals as those used in Embodiment 1, and an explanation of the components will be omitted or simplified.

The travelling predicting unit 106 acquires at least one of a shot image which an external camera 801 acquires by shooting another vehicle (referred to as a preceding vehicle hereafter) travelling ahead of the host vehicle, lighting information about traffic light received from roadside equipment 802, and so on. The camera 801 is mounted in, for example, a front portion of the host vehicle in such a way as to be able to shoot the stop lamp of a preceding vehicle. The roadside equipment 802 delivers information for controlling the lighting of the traffic light.

The travelling predicting unit 106 predicts whether the host vehicle will start to travel, from at least one of the acquired shot image of the preceding vehicle, the lighting information about the traffic light, and so on. The travelling predicting unit 106 refers to, for example, the shot image of the preceding vehicle, and, when the stop lamp of the preceding vehicle has changed from the lighting state to the lights-out state, predicts that the host vehicle will start to travel. Further, the travelling predicting unit 106 refers to the lighting information about the traffic light, and, when the traffic light changes to the green light after a lapse of a predetermined time (e.g., three seconds), predicts that the host vehicle will start to travel. The travelling predicting unit 106 outputs the result of the prediction to the control unit 103a.

When there is also information which makes it possible to predict whether the host vehicle will start to travel, other than a shot image of a preceding vehicle and lighting information about traffic light, it is possible to predict whether the host vehicle will start to travel by referring to the information.

When the vehicle speed is “0” or the parking brake is in the ON state, the control unit 103a further refers to the result of the prediction by the travelling predicting unit 106, and determines whether or not it is predicted that the vehicle will start to travel. When it is predicted that the vehicle will start to travel, the control unit 103a assumes that the vehicle is travelling. In contrast, when it is not predicted that the vehicle will start to travel, the control unit 103a determines that the vehicle is not travelling.

Next, the operation of the vehicle-mounted information processing device 100b will be explained.

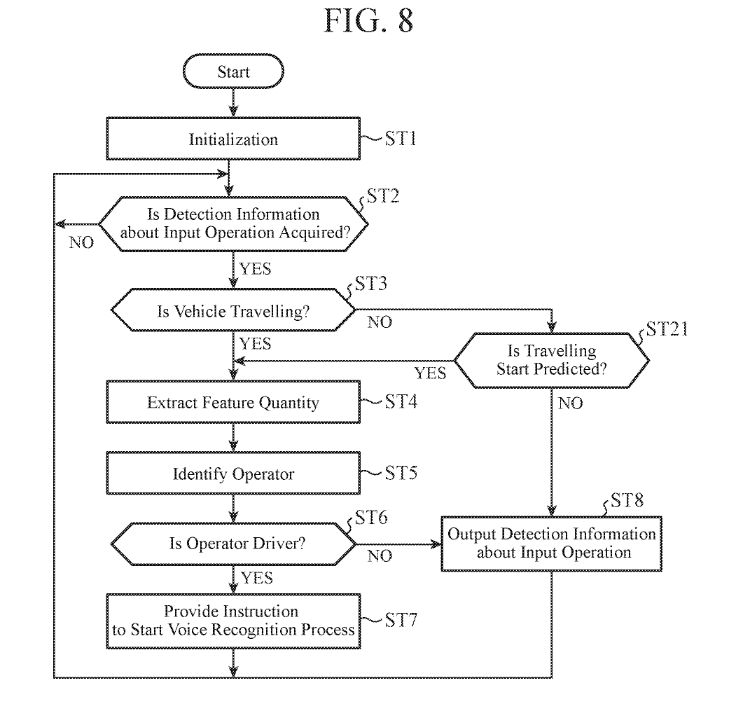

FIG. 8 is a flowchart showing the operation of the vehicle-mounted information processing device 100b according to Embodiment 3.

Hereafter, the same steps as those of the vehicle-mounted information processing device 100 according to Embodiment 1 are denoted by the same reference numerals as those used in FIG. 3, and an explanation of the steps will be omitted or simplified.

When the control unit 103a, in step ST3, determines that the vehicle is not travelling (NO in step ST3), the control unit 103a further refers to a result of the prediction by the travelling predicting unit 106 and determines whether or not it is predicted that the vehicle will start to travel (step ST21). When it is predicted that the vehicle will start to travel (YES in step ST21), the control unit 103a assumes that the vehicle is travelling and advances to a process of step ST4. In contrast, when it is not predicted that the vehicle will start to travel (NO in step ST21), the control unit 103a determines that the vehicle is not travelling and advances to a process of step ST8.

As mentioned above, according to Embodiment 3, it is configured in such a way that the travelling predicting unit 106 that predicts whether the vehicle which is not travelling will start to travel is included, and the control unit 103a determines that the vehicle is travelling when vehicle information shows that the vehicle is stationary and when the travelling predicting unit 106 predicts that the vehicle will start to travel. Even when the vehicle is not travelling, whether the vehicle will start to travel can be predicted and a start of the voice recognition process can be controlled, and operability provided for the driver can be improved.

Although in above-mentioned Embodiment 3 the configuration is described in which the travelling predicting unit 106 is additionally included in the vehicle-mounted information processing device 100 shown in Embodiment 1, a configuration can be provided in which the travelling predicting unit 106 is additionally included in the vehicle-mounted information processing device 100a shown in Embodiment 2.

Further, although in above-mentioned Embodiment 3 the configuration is described in which the travelling predicting unit 106 in the vehicle-mounted information processing device 100a acquires the lighting information about the traffic light transmitted from the roadside equipment, and predicts whether the host vehicle will start to travel, from the acquired information, a configuration can be provided in which an external server predicts whether the host vehicle will start to travel on the basis of the lighting information about the traffic light, the position information about the host vehicle, and so on, and inputs a result of the prediction to the vehicle-mounted information processing device 100b.

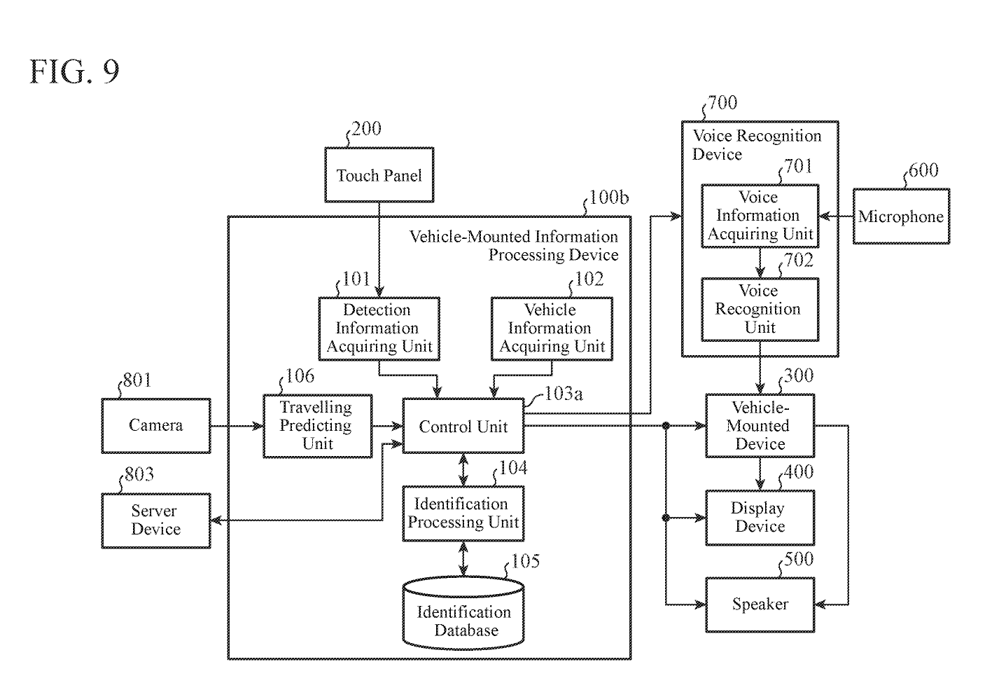

FIG. 9 shows a configuration in which a server device 803 is included and a result of the prediction of whether the host vehicle will start to travel is inputted from the server device 803 to the control unit 103a of the vehicle-mounted information processing device 100b. The vehicle-mounted information processing device 100b transmits the position information about the host vehicle, and so on to the server device 803. The server device 803 predicts whether the host vehicle will start to travel from the stored lighting information about the traffic light, and the position information about the host vehicle and so on which are transmitted from the vehicle-mounted information processing device 100b, and transmits the result of the prediction to the vehicle-mounted information processing device 100b.

The camera 801 shoots a preceding vehicle and inputs a shot image to the travelling predicting unit 106. The travelling predicting unit 106 predicts whether the vehicle will start to travel from the inputted image. The control unit 103a determines whether or not it is predicted that the vehicle will start to travel on the basis of the prediction result inputted from the server device 803, and the prediction result inputted from the travelling predicting unit 106. Further, the server device 803 shown in FIG. 9 can be configured to include the function of a voice recognition device 700.

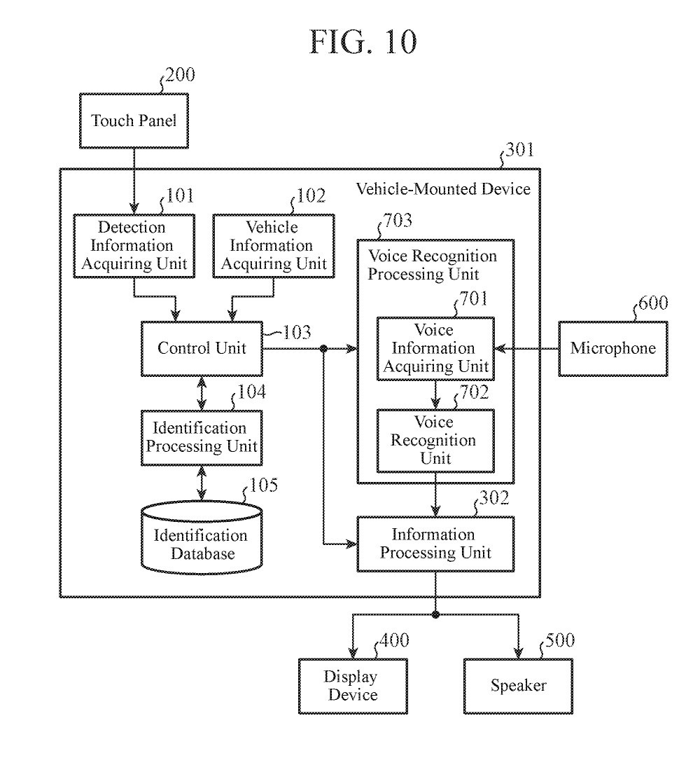

In addition, as shown in FIG. 10, a vehicle-mounted device can also be configured to include the functions of any one of the vehicle-mounted information processing devices 100, 100a and 100b shown in Embodiments 1 to 3. FIG. 10 is a block diagram showing the configuration of the vehicle-mounted device 301 which employs components shown in Embodiment 1.

Because a detection information acquiring unit 101, a vehicle information acquiring unit 102, a control unit 103, an identification processing unit 104, an identification database 105, a voice information acquiring unit 701, and a voice recognition unit 702 which are shown in FIG. 10 are the same as the components shown in Embodiment 1, the components are denoted by the same reference numerals and an explanation of the components will be omitted hereafter.

An information processing unit 302 includes a navigation function, an audio playback function, an information output limiting function, and so on. The information processing unit 302 performs information processing such as a route search and route guidance, display control such as display of map information, output control of audio information, display control and sound output control of information of which occupants in the vehicle should be notified, and so on, on the basis of control information inputted from the control unit 103 or a voice recognition result inputted from a voice recognition processing unit 703. Display control and sound output control of navigation information, output control of audio information, and display control and sound output control of information of which users should be notified are performed.

A display device 400 displays the navigation information, the audio information, the information of which users should be notified, and so on in accordance with control of the information processing unit 302.

A speaker 500 outputs by voice the navigation information, the audio information, and the information of which users should be notified in accordance with control of the information processing unit 302.

Although in FIG. 10 the vehicle-mounted device 301 including the functions of the vehicle-mounted information processing device 100 shown in Embodiment 1 is shown, a vehicle-mounted device can be configured to include the functions of the vehicle-mounted information processing device 100a or 100b shown in Embodiment 2 or 3.

In above-mentioned Embodiments 1 to 3, it is assumed that passengers include a passenger sitting in the front seat next to the driver and a passenger sitting in a rear seat.

It is to be understood that, in addition to the above-mentioned embodiments, any combination of two or more of the above-mentioned embodiments can be made, various changes can be made in any component according to any one of the above-mentioned embodiments, and any component according to any one of the above-mentioned embodiments can be omitted within the scope of the invention.

### INDUSTRIAL APPLICABILITY

Because the vehicle-mounted information processing device according to the present invention starts a voice recognition process when accepting the driver's operation while the vehicle is travelling, the vehicle-mounted information processing device is suitable to use for a vehicle-mounted navigation device or a vehicle-mounted audio device, and improve the operability.

### REFERENCE SIGNS LIST

100, 100a, 100b vehicle-mounted information processing device, 101, 101a detection information acquiring unit, 102 vehicle information acquiring unit, 103, 103a control unit, 104 identification processing unit, 105 identification database, 106 travelling predicting unit, 200 touch panel, 201 H/W switch, 202 infrared camera, 300, 301 vehicle-mounted device, 302 information processing unit, 400 display device, 500 speaker, 600 microphone, 700 voice recognition device, 701 voice information acquiring unit, 702 voice recognition unit, 703 voice recognition processing unit, 801 camera, 802 roadside equipment, and 803 server device.

1.-11. (canceled)

12. A vehicle-mounted information processing device comprising:
a detection information acquirer to acquire detection information showing that an operator's input operation has been detected;
a vehicle information acquirer to acquire vehicle information showing a travelling state of a vehicle;
an identification processor to identify the operator who has performed the input operation; and
a controller to control either output of the detection information or a start of a voice recognition process of recognizing the operator's voice, on a basis of either the vehicle information or the vehicle information and a result of the identification by the identification processor,
wherein the detection information is a shot image acquired by shooting the operator's input operation,
and wherein when determining from the vehicle information that the vehicle is travelling, the controller extracts a feature quantity of the operator from the shot image acquired by shooting the operator's input operation, and the identification processor makes a comparison of the feature quantity of the operator which is extracted by the controller, to identify whether or not the operator is a driver.

13. The vehicle-mounted information processing device according to claim 12, wherein the controller controls a start of the voice recognition process when the identification processor identifies that the operator is the driver.

14. The vehicle-mounted information processing device according to claim 12, wherein the controller controls output of the detection information when the identification processor identifies that the operator is not the driver.

15. The vehicle-mounted information processing device according to claim 12, wherein when determining from the vehicle information that the vehicle is not travelling, the controller controls output of the detection information.

16. The vehicle-mounted information processing device according to claim 12, further comprising a travelling predictor to predict whether the vehicle which is determined to be not travelling by the controller from the vehicle information will start to travel, and wherein the controller assumes that the vehicle which is predicted to start to travel by the travelling predictor is travelling.

17. The vehicle-mounted information processing device according to claim 16, wherein the travelling predictor predicts whether the vehicle will start to travel by using at least one of a shot image acquired by shooting another vehicle travelling ahead of the vehicle, and lighting information about traffic light.

18. The vehicle-mounted information processing device according to claim 16, wherein the controller acquires, from an external server, information showing a prediction of whether the vehicle will start to travel, the prediction being made on a basis of lighting information about traffic light.

19. A vehicle-mounted information processing device comprising:
a detection information acquirer to acquire detection information showing that an operator's input operation has been detected;
a vehicle information acquirer to acquire vehicle information showing a travelling state of a vehicle;
an identification processor to identify the operator who has performed the input operation;
a controller to control either output of the detection information or a start of a voice recognition process of recognizing the operator's voice, on a basis of either the vehicle information or the vehicle information and a result of the identification by the identification processor;
a voice recognition processor to perform voice recognition on the operator's uttered voice on a basis of control of the controller; and
an information processor to perform information processing and information presentation on a basis of both control of the controller and a voice recognition result of the voice recognition processor, and to, when a voice recognition process by the voice recognition processor is started, present information providing a notification of a start of the voice recognition process,
wherein the detection information is a shot image acquired by shooting the operator's input operation,
and wherein when determining from the vehicle information that the vehicle is travelling, the controller extracts a feature quantity of the operator from the shot image acquired by shooting the operator's input operation, and the identification processor makes a comparison of the feature quantity of the operator which is extracted by the controller, to identify whether or not the operator is a driver.

20. A vehicle-mounted information processing method comprising:
acquiring detection information showing that an operator's input operation has been detected;
acquiring vehicle information showing a travelling state of a vehicle;
determining whether or not the vehicle is travelling from the vehicle information;
identifying the operator who has performed the input operation when it is determined that the vehicle is travelling; and
controlling either output of the detection information or a start of a voice recognition process of recognizing the operator's voice, on a basis of either the vehicle information or the vehicle information and an identification result of identifying the operator,
wherein the detection information is a shot image acquired by shooting the operator's input operation,
and when determining from the vehicle information that the vehicle is travelling,
extracting a feature quantity of the operator from the shot image acquired by shooting the operator's input operation, and
comparing the feature quantity of the operator which is extracted in the extracting step, to identify whether or not the operator is a driver.
